(19) United States
(12) Patent Application Publication
(10) Pub. No.: US 2024/0149321 A1
(43) Pub. Date: May 9, 2024

(54) CALCULATION METHOD FOR HEATING PLAN, PROGRAM, RECORDING MEDIUM, DEVICE, DEFORMATION METHOD, PLATE DEFORMATION DEVICE, AND PRODUCTION METHOD FOR DEFORMED PLATE

(71) Applicant: UNIVERSITY PUBLIC CORPORATION OSAKA, Osaka-shi, Osaka (JP)

(72) Inventors: Masakazu SHIBAHARA, Sakai-shi, Osaka (JP); Takuya KATO, Sakai-shi, Osaka (JP); Kazuki IKUSHIMA, Sakai-shi, Osaka (JP); Shintaro MAEDA, Sakai-shi, Osaka (JP)

(73) Assignee: UNIVERSITY PUBLIC CORPORATION OSAKA, Osaka-shi, Osaka (JP)

(21) Appl. No.: 18/280,804

(22) PCT Filed: Mar. 4, 2022
(86) PCT No.: PCT/JP2022/010750

§ 371 Date: Sep. 7, 2023

(30) Foreign Application Priority Data
Mar. 8, 2021 (JP) 2021-036189

(51) Int. Cl. B21D 11/20; G05D 23/19

(52) U.S. Cl. CPC B21D 11/20; G05D 23/1917; G06F 30/27

(57) ABSTRACT

To provide a calculation method that enables a heating plan for approximating a plate to an intended shape to be calculated in a short period of time.

A calculation method according to the present invention is a calculation method of a heating plan for deforming a plate by heating, the calculation method including: a Bayesian optimization step of performing a Bayesian optimization by inputting a training data group including a plurality of combinations of heating conditions that include a heating shape having been set at an arbitrary location of an analysis model for an original shape being a shape of the plate and a shape that has been calculated based on the heating conditions and determining a heating conditions candidate; and a finite element analysis step of converting the heating conditions candidate into strain data and performing a structural analysis based on a finite element method by inputting the strain data to output a shape candidate.

### TECHNICAL FIELD

The present invention relates to a calculation method for a heating plan, a program, a recording medium, a device, a deformation method, a plate deformation device, and a production method for a deformed plate.

### BACKGROUND ART

Complex curved shapes are present in a bow, a bulbous bow, a stern, or the like of a ship. In order to create such curved shapes, a plurality of steel plates are subjected to bending work and are then joined to each other by welding.

In addition, in building of large ships or the like, a block construction system is adopted which is a construction system where a hull is manufactured in several divided blocks and the blocks are joined together by welding in a final step. The system realizes a shorter work period and increased work efficiency during the construction of a ship. However, unless welding deformation that occurs during block construction is eliminated, since a quality of connection of welded portions decline during assembly of blocks, work for strain relief is necessary.

As a technique for such bending work and strain relief, linear heating is widely used in the field of shipbuilding. Linear heating makes use of thermal deformation that occurs when heating a surface of a steel plate with a gas burner. For example, by pouring water over a steel plate while locally heating the steel plate with a flame of the gas burner to quench a heated portion, the steel plate plastically deforms. Accordingly, by causing an angular deformation in a part of the steel plate or by causing a part of the steel plate to contract, a complex deformation can be created. The plastic deformation can be controlled by varying a movement speed of the gas burner used for heating, a mixing ratio of combustion gas and inflow oxygen, a distance between the burner and the steel plate, or the like to adjust a heat input to the steel plate. In bending work or strain relief by linear heating, a steel plate is approximated to an intended curved surface by arranging a plurality of heating wires at suitable positions.

However, deformation that occurs during linear heating is complex deformation which is a mixture of longitudinal contraction, transverse contraction, longitudinal bending, and transverse bending and which is also dependent on an amount of heat input, a movement speed of a gas burner, a heating position, and the like. In particular, a relationship between the amount of heat input and angular deformation is non-linear. Therefore, it is extremely difficult to make a prediction and bending work using linear heating is one of the techniques considered difficult to automate. Methods of calculating heating plans to be used to realize automation of bending work using linear heating have been proposed (for example, refer to Patent Literature 1 and 2).

According to the calculation method disclosed in Patent Literature 2, it is described that since a selection of heating wires for approximating a metal plate to an intended shape from heating wires set at various positions is repeatedly performed, a heating plan including a plurality of heating wires that are optimal for approximating the metal plate to the intended shape can be calculated. It is also described that, by heating the metal plate based on the calculated heating plan, the metal plate can be deformed to a shape that approximates the intended shape.

### CITATION LIST

### Patent Literature

Patent Literature 1: Japanese Patent Laid-Open No. 2013-66902
Patent Literature 2: Japanese Patent Laid-Open No. 2020-40092

### SUMMARY OF INVENTION

### Technical Problem

However, while a conventional calculation method based on a Monte Carlo method such as that disclosed in Patent Literature 2 involves performing a finite element structural analysis a plurality of times to calculate heating wire candidates, the method described above requires a long calculation time since heating wire candidates are randomly generated. For this reason, there is a need to make calculation methods of a heating plan more efficient.

Therefore, an object of the present invention is to provide a calculation method that enables a heating plan for approximating a plate to an intended shape to be calculated in a short period of time.

### Solution to Problem

As a result of extensive studies carried out in order to achieve the object described above, the present inventors have discovered that combining analysis based on a finite element method and Bayesian optimization enables a heating plan for approximating a plate to an intended shape to be calculated in a short period of time.

The present invention was completed based on these findings.

Specifically, the present invention provides a calculation method of a heating plan for deforming a plate by heating, the calculation method including: a Bayesian optimization step of performing a Bayesian optimization by inputting a training data group including a plurality of combinations of heating conditions that include a heating shape having been set at an arbitrary location of an analysis model for an original shape being a shape of the plate and an assessed value of a deformed shape that has been calculated based on the heating conditions and determining a heating conditions candidate; and

a finite element analysis step of converting the heating conditions candidate into strain data and performing a structural analysis based on a finite element method by inputting the strain data to output a shape candidate.

Preferably, the calculation method described above includes a training data group output step of outputting the heating conditions and the deformed shape by deformation prediction using a neural network.

Preferably, the calculation method described above includes:

a Bayesian optimization step of performing the Bayesian optimization with the shape candidate obtained in the finite element analysis step as the original shape and determining a next heating conditions candidate; and

a finite element analysis step of converting the next heating conditions candidate into strain data and performing a structural analysis based on a finite element method by inputting the strain data to output a next shape candidate.

Preferably, in the calculation method described above, the Bayesian optimization and the subsequent finite element analysis step are repetitively performed with the next shape candidate as the original shape to acquire an intended shape and a plurality of heating conditions candidates for obtaining the intended shape.

Preferably, the heating shape described above includes a heating wire and the heating conditions described above include a midpoint of the heating wire, a length of the heating wire, an angle of the heating wire, a heating surface, and a heat input amount.

Preferably, the calculation method described above is a calculation method of a heating plan for performing bending work of a plate or strain relief of a plate due by heating.

In addition, the present invention provides a program for executing the calculation method described above.

Furthermore, the present invention provides a computer-readable recording medium that stores the program described above.

In addition, the present invention provides a device including a calculating unit that executes acquisition of a heating plan according to the calculation method described above.

Furthermore, the present invention provides a deformation method of heating and deforming a plate based on a heating plan calculated by the calculation method described above.

In addition, the present invention provides a plate deformation device equipped with a program for executing the deformation method described above.

Furthermore, the present invention provides a plate deformation device including a heating unit that heats a plate and a control unit that controls the deformation device, wherein the control unit is provided so as to be capable of reading the heating plan described above.

Preferably, the plate deformation device includes: deforming means (A) which heats a plate using an n-th heating conditions candidate outputted by an n-th (n≥1) attempt to deform the plate: measuring means which measures a three-dimensional shape of the deformed plate; comparing means which compares the measured three-dimensional shape of the plate and an n-th shape candidate that is an analysis result of a finite element structural analysis performed in the n-th attempt with each other; and deforming means (B) which heats the plate based on a result of the comparison so that a three-dimensional shape of the plate approximates the analysis result.

In addition, the present invention provides a production method for a deformed plate including a step of heating and deforming a plate based on a heating plan calculated by the calculation method described above.

### Advantageous Effects of Invention

With the calculation method according to the present invention, a heating plan for approximating a plate to an intended shape can be calculated in a short period of time. In addition, by heating a plate based on the calculated heating plan, the plate can be deformed to a shape that approximates the intended shape.

### BRIEF DESCRIPTION OF DRAWINGS

FIG. 1 is a flow chart showing an embodiment of a calculation method according to the present invention.

FIG. 2 is a diagram for describing an analysis model used in a finite element structural analysis.

FIG. 3 is a diagram for describing an analysis model used in a finite element structural analysis and a heating conditions candidate output by a Bayesian optimization.

FIG. 4 is a diagram for describing a method of comparing an analysis result and an intended shape with each other.

FIG. 5 is a diagram showing an analysis model of an intended shape in a first example.

FIG. 6 is a diagram showing a heating plan calculated with respect to an 8 mm-thick model in the first example.

FIG. 7 is a diagram showing a heating plan calculated with respect to a 4 mm-thick model in the first example.

FIG. 8 is a graph showing a relationship between the number of heating wires and a sum of errors in the first example.

FIG. 9 is a diagram showing an analysis model of an intended shape in a second example.

FIG. 10 is a diagram showing a heating plan calculated with respect to an 8 mm-thick model in the second example.

FIG. 11 is a diagram showing a heating plan calculated with respect to a 4 mm-thick model in the second example.

FIG. 12 is a graph showing a relationship between the number of heating wires and a sum of errors in the second example.

FIG. 13 is a diagram showing an analysis model of a stiffening structure used in creating a heating plan in a third example.

FIG. 14 is a diagram showing a heating plan calculated in the third example.

FIG. 15 is a diagram showing a deformation analysis result when performing heating in the heating plan obtained in the third example.

FIG. 16 is a diagram showing an analysis model of a stiffening structure having a torsional deformation used in creating a heating plan in a fourth example.

FIG. 17 is a diagram showing a heating plan calculated in the fourth example.

FIG. 18 is a diagram showing a deformation analysis result when performing heating in the heating plan obtained in the fourth example.

FIG. 19 is a visualized view of an assessed value distribution that emphasizes coordinates (x, y) of a midpoint of a first heating wire in a fifth example.

FIG. 20 is a visualized view of an assessed value distribution that emphasizes coordinates (x, y) of a midpoint of a second heating wire in the fifth example.

FIG. 21 is a visualized view of an assessed value distribution that emphasizes coordinates (x, y) of a midpoint of a tenth heating wire in a sixth example.

FIG. 22 is a visualized view of an assessed value distribution that emphasizes coordinates (x, y) of a midpoint of a first heating wire in a seventh example.

FIG. 23 is a diagram showing an analysis model of a stiffening structure used in creating a heating plan and a deformation analysis result when performing heating in the obtained heating plan in an eighth example.

FIG. 24 is a diagram showing the heating plan calculated in the eighth example.

FIG. 25 is a diagram showing an error transition when creating the heating plan obtained in the eighth example.

FIG. 26 is a diagram showing an analysis model of a stiffening structure used in creating a heating plan and a deformation analysis result when performing heating in the obtained heating plan in a ninth example.

FIG. 27 is a diagram showing the heating plan calculated in the ninth example.

FIG. 28 is a diagram showing an error transition when creating the heating plan obtained in the ninth example.

### DESCRIPTION OF EMBODIMENT

### [Calculation Method of Heating Plan]

A calculation method according to the present invention is a calculation method of a heating plan for deforming a plate by heating, the calculation method at least including: a Bayesian optimization step of performing a Bayesian optimization by inputting a training data group including a plurality of combinations of heating conditions that include a heating shape having been set at an arbitrary location of an analysis model for an original shape being a shape of the plate and an assessed value of a deformed shape that has been calculated based on the heating conditions and determining a heating conditions candidate; and a finite element analysis step of converting the heating conditions candidate into strain data and performing a structural analysis based on a finite element method (FEM) by inputting the strain data to output a shape candidate.

The calculation method described above may be any calculation method of a heating plan for deforming a plate by heating and specific examples include bending work of the plate and strain relief of the plate.

Examples of the plate described above include metallic plates such as an iron plate, an aluminum plate, and a titanium plate and non-metallic plates such as a plastic plate and a carbon plate. In particular, metallic plates are preferable.

While the heating shape described above is not particularly limited, examples include linear (a heating wire), point-like (a heating point), planar (a heating surface), and a shape combining one or more of these shapes. Heating in a linear shape may be referred to as “linear heating” and heating in a point-like shape may be referred to as “point heating”. In addition, the heating described above may combine a plurality of types of heating such as linear heating and point-like heating. Specifically, a heating wire to perform the linear heating may be a straight wire, a curved wire, or a wire that is a combination thereof (a V-shape or a triangular shape).

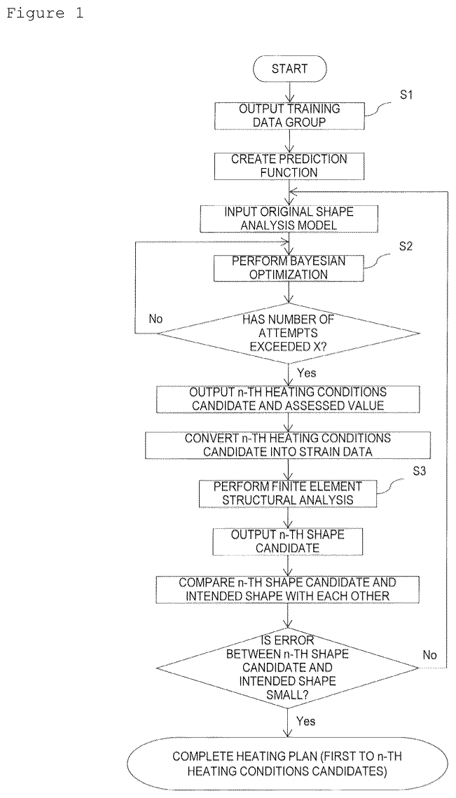

An embodiment of the calculation method according to the present invention will be described using the flow chart shown in FIG. 1. Note that components shown in the drawings and described below are exemplary and that the scope of the present invention is not limited to the scope represented by the drawings and the description given below.

### (Training Data Group Output Step)

In the present embodiment, first, a training data group output step S1 outputs a training data group to be input when performing a Bayesian optimization or, more specifically, a training data group for creating a prediction function to be used in the Bayesian optimization. Each individual piece of training data in the training data group at least includes heating conditions and an assessed value of a deformed shape calculated based on the heating conditions.

As the training data, for example, a database of modified strain during curved surface processing of a flat plate or during various types of welding such as T-Joint welding, butt welding, and lap welding can be used. As the database, [heat input amount—modified strain relationship] can be used.

In the training data group output step, heating conditions are inputted and an assessed value of a deformed shape is outputted. The outputted assessed value of a deformed shape is also an assessed value of the heating conditions. Known or conventional methods can be used to output the training data group and, for example, the training data group can be outputted by a finite element analysis or deformation prediction using a neural network.

In particular, the training data group is preferably outputted by deformation prediction using a neural network. When using a neural network, a plurality of randomly selected heating conditions are input to an already-constructed neural network and deformed shapes calculated based on the heating conditions are outputted. The deformed shapes are converted into assessed values of the deformed shapes and the heating conditions and the converted assessed values can be adopted as the training data group to be used in a Bayesian optimization. The deformation prediction using the neural network includes around 10,000 randomly selected heating conditions and, by globally completing estimation of a distribution of assessed values to be performed by Bayesian optimization, a global optimal solution can be found while significantly reducing the number of deformation analyses by a finite element analysis which require a long calculation time.

The neural network can be constructed by inputting, for example, a large amount of combinations of a state prior to heating deformation (for example, a shape prior to heating deformation (displacement before heating), a stress in a shape prior to heating deformation (stress before heating), a strain in a shape prior to heating deformation (strain before heating), and the like) and a state after heating deformation (for example, a displacement that increases due to heating (displacement increment after heating)).

Next, the training data group is inputted to create a prediction function in order to perform a Bayesian optimization.

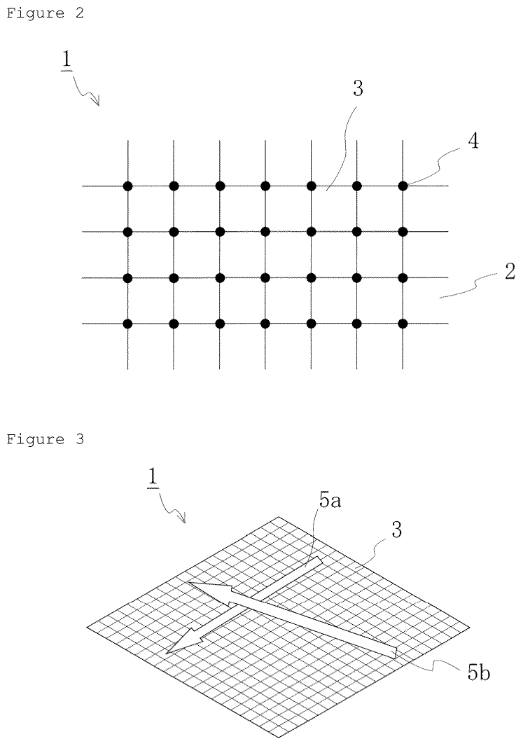

Next, a shape prior to heating of the plate for which a calculation of a heating plan is to be performed is adopted as an original shape and an analysis model of the original shape is created. An example of a method of creating the analysis model will be described with reference to FIG. 2 and FIG. 3. A length, a width, a thickness, and the like of a plate 2 are set to an analysis model 1 shown in FIG. 2. In addition, the analysis model 1 is divided into a plurality of elements (mesh). Each element 3 may be a shell of a polygon such as a square or a triangle or a solid such as a cube, a rectangular parallelopiped, a triangular pyramid, or a triangular prism. In addition, each vertex of the element 3 becomes a node 4. For example, the analysis model 1 shown in FIG. 3 is divided into 20×20 (400) elements 3. In this case, the analysis model 1 becomes a grid pattern and each intersection becomes the node 4. When the intended shape is not a flat sheet shape, the analysis model 1 can be created by moving the nodes 4 so that a shape of an analysis model of the plate matches the original shape.

In addition, an analysis model of the intended shape is created in a similar manner to the analysis model of the original shape. The intended shape is a shape to be a target after bending work or strain relief of the plate. The analysis model of the intended shape is created by moving the nodes 4 in a similar manner to the method of creating the analysis model of the original shape.

### (Bayesian Optimization Step)

In the Bayesian optimization step S2, the training data group and the analysis model of the original shape are inputted, a Bayesian optimization is performed using the prediction function, and heating conditions and a difference from the intended shape as an assessed value are outputted as a set. The number of attempts of the Bayesian optimization is set to X times in the flow chart shown in FIG. 1, in which case a value of X can be appropriately set. While more optimal heating conditions can be obtained with a larger number of attempts, the assessed values stabilize once a given number of attempts is exceeded. Therefore, the number of attempts of Bayesian optimization is, for example, 100 to 100,000 times and, preferably, 5,000 to 50,000 times. Since the time required by the Bayesian optimization is significantly shorter than the time required to repeat structural analyses by the finite element method, adopting Bayesian optimization enables more suitable heating conditions to be searched in a short period of time.

Each piece of training data includes, for example, a plurality of combinations of heating conditions including a heating shape outputted in the training data group output step S1 described above and a shape calculated based on the heating conditions. The heating conditions at least include information related to the heating shape. When the heating shape includes a heating wire, information related to the heating wire preferably includes one or more of a midpoint of the heating wire, a length of the heating wire, an angle of the heating wire, a heating surface, and a heat input amount and more preferably includes all of the same. Examples of heating conditions other than the heating shape include a heating position, heating means (selection of a heating device such as a burner, a laser, welder, or the like), a heating rate, a presence or absence of cooling water, and an amount of cooling water.

In Bayesian optimization, specifically, first, a difference between a shape obtained by randomly selected heating conditions and an intended shape is outputted as an assessed value and, next, a difference between a shape obtained by other randomly selected heating conditions and the intended shape is outputted as an assessed value. In addition, from next time on, heating conditions are searched while estimating an objective function having a difference from the intended shape as an assessed value and heating conditions that approximate heating conditions with a higher assessed value and an assessed value based on the heating conditions are outputted. In this manner, by performing a Bayesian optimization by repetitively performing selection of heating conditions and outputting an assessed value based on the heating conditions, heating conditions with a higher assessed value or, in other words, heating conditions capable of obtaining a shape with a smaller difference from the intended shape can be outputted. Furthermore, the heating conditions obtained by the Bayesian optimization are determined as a first heating conditions candidate (for example, a first heating conditions candidate 5a shown in FIG. 3). While heating conditions with a highest assessed value among the heating conditions obtained by Bayesian optimization is preferably determined as the first heating conditions candidate, other heating conditions may be determined as the first heating conditions candidate. While examples shown in FIG. 3 onward will be described as examples of performing linear heating, calculations can be performed in a similar manner even with heating of shapes other than linear heating.

### (Finite Element Analysis Step)

Next, the first heating conditions candidate obtained in the Bayesian optimization step S2 is converted into strain data. In addition, in the finite element analysis step S3, the strain data is inputted, a structural analysis by a finite element method is performed, and a shape candidate is outputted.

In the structural analysis by a finite element method, a finite element structural analysis is performed by inputting the analysis model of the original shape and the strain data. In the finite element structural analysis, a strain converted from the set first heating conditions candidate is added to the element 3 selected from the first heating conditions candidate and an analysis result (an analysis model deformed by a structural analysis) is obtained as a first shape candidate (first shape candidate output). Specific examples of a method of converting the first heating conditions candidate into strain data include the method disclosed in Patent Literature 2 described earlier.

The finite element structural analysis may be an FEM thermal elasto-plastic analysis or an elastic analysis by an inherent strain method. In structural analysis, heating using a gas burner may be assumed, heating using a laser (laser forming or the like) may be assumed, or heating using induction heating may be assumed. In addition, in structural analysis, a physical property value (Young's modulus, Poisson's ratio, density, or the like) of a material of a plate to be a heating object is used.

In an FEM thermal elasto-plastic analysis, an inherent strain amount of four components of a longitudinal contraction, a transverse contraction, an angular deformation, and longitudinal bending of an element selected with respect to the heating conditions candidate is calculated. In an FEM thermal elasto-plastic analysis, since a deformation analysis is performed by sequentially reproducing a thermal history and a deformation history, a transient situation can be analyzed. In an elastic analysis by an inherent strain method, a deformation of a plate (analysis model) due to heating is considered to occur due to inherent deformation. When the inherent deformation is known, a deformation of a plate due to heating can be predicted by adding the inherent deformation as a forced strain along a heating shape in elastic analysis. Therefore, in an elastic analysis by an inherent strain method, a structural analysis is performed using an inherent strain having been calculated or measured in advance. For example, an inherent strain calculated using FEM thermal elasto-plastic analysis or an inherent strain obtained by measuring a plate that has actually been heated and deformed can be used in an elastic analysis by an inherent strain method. In addition, an elastic analysis by an inherent strain method can be performed using a formula representing a relationship between a heat input amount calculated or measured in advance and an inherent strain. Furthermore, since an inherent strain method is an elastic analysis, one of the features of the inherent strain method is that a calculation time is significantly shorter than a calculation time required by a thermal elasto-plastic analysis.

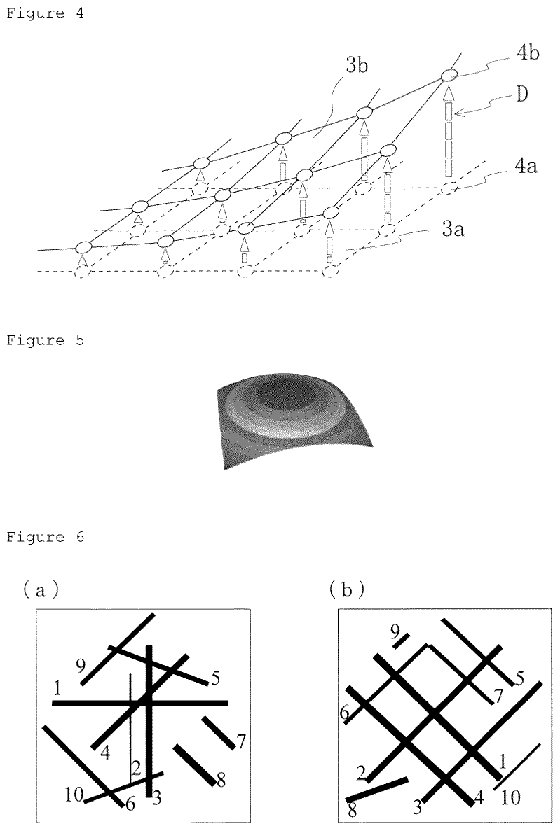

Next, the first shape candidate that is an analysis result and the intended shape are compared with each other and an error between the first shape candidate and the intended shape is assessed. In addition, the error and the set first heating conditions candidate are stored in a storage unit. As an assessment index, for example, an out-of-plane direction displacement amount or a curvature of a node can be used. FIG. 4 is an explanatory diagram of a comparison between the first shape candidate and the intended shape in a case where an out-of-plane direction displacement amount D of a node 4a is used as the assessment index. In FIG. 4, the first shape candidate has an element 3a and the node 4a. For example, as shown in FIG. 4, a displacement amount (error) in an out-of-plane direction from the node 4a of the first shape candidate to a node 4b of the intended shape having a corresponding element 3b and the corresponding node 4b is calculated. A flow from inputting the original shape analysis model to storing the first heating conditions candidate and the first shape candidate will be referred to as a first attempt.

When an error between the first shape candidate obtained by the first attempt and the intended shape is small and within an allowable range, the first heating conditions candidate is calculated as a heating plan. On the other hand, when the error between the first shape candidate and the intended shape is outside of the allowable range, a second attempt is performed.

The second attempt is for outputting a second heating conditions candidate that is heating conditions for next heating and deforming the plate having been heated and deformed according to the first heating conditions candidate. While a flow of the second attempt is basically the same as the flow of the first attempt, the prediction function used in the first attempt is used in a Bayesian optimization. In addition, in the second attempt, the original shape analysis model inputted to the Bayesian optimization is adopted as the analysis model of the first shape candidate. The Bayesian optimization in the second attempt is performed in a state where the objective function created in the Bayesian optimization in the first attempt has been deleted. In other words, as the training data group used in the Bayesian optimization in the second attempt, a deformation prediction using a neural network and an analysis result by a finite element structural analysis can be used in combination. In this manner, a neural network and a finite element structural analysis can be selectively used in an efficient manner while taking a calculation speed and a prediction accuracy into consideration. Accordingly, by searching an optimal heating shape using the prediction function obtained by the Bayesian optimization in the first attempt and a finite element structural analysis, optimal heating conditions can be obtained by a small number of attempts. In this manner, heating conditions with a high assessed value are outputted by the Bayesian optimization and the heating conditions are determined as a second heating conditions candidate (for example, a second heating conditions candidate 5b shown in FIG. 3). While heating conditions with a highest assessed value among the heating conditions obtained by the Bayesian optimization are preferably determined as the second heating conditions candidate, other heating conditions may be determined as the second heating conditions candidate.

In addition, the obtained second heating conditions candidate is converted into strain data and, in the finite element analysis step S3, the strain data is inputted, a structural analysis by a finite element method is performed, and a second shape candidate is outputted as an analysis result. By performing the second attempt in this manner, an analysis result (the second shape candidate) reflecting both the first heating conditions candidate and the second heating conditions candidate can be obtained.

Next, the second shape candidate that is an analysis result and the intended shape are compared with each other, an error between the second shape candidate and the intended shape is assessed, and the error and the set second heating conditions candidate are stored in the storage unit. When the error between the second shape candidate and the intended shape is small and within an allowable range, a heating plan is calculated which adopts the first heating conditions candidate as heating conditions of a first attempt and the second heating conditions candidate as heating conditions of a second attempt. On the other hand, when the error between the second shape candidate and the intended shape is outside of the allowable range, a third attempt is performed. The third attempt is the same as the second attempt with the exception of using a second shape candidate analysis model as the original shape analysis model.

In this manner, the attempt described above is repeated a plurality of times until a state is reached where the error between a shape candidate outputted in the finite element analysis step and the intended shape is within the allowable range. Note that as described above, when the error between the first shape candidate and the intended shape is within the allowable range, the second attempt need not be performed. In addition, when an error between an n-th shape candidate outputted in an n-th (n Z 1) attempt and the intended shape is within the allowable range, a heating plan is calculated which determines heating conditions by adopting the first heating conditions candidate as heating conditions of the first attempt, adopting the second heating conditions candidate as heating conditions of the second attempt, and so on and which sequentially performs n-number of attempts of heating up to the n-th attempt.

Specifically, when n is an integer of 2 or more, a heating plan is calculated by the calculation method described above which includes: a Bayesian optimization step of performing the Bayesian optimization described above using a shape candidate obtained in the finite element analysis step described above as the original shape to determine a next heating conditions candidate; and a finite element analysis step of converting the next heating conditions candidate into strain data and performing a structural analysis by a finite element method by inputting the strain data to output a next shape candidate.

With the calculation method according to the present invention, by executing a finite element structural analysis and a Bayesian optimization in combination, a heating plan for approximating a plate to an intended shape can be calculated in a shorter period of time than a conventional calculation method based on a Monte Carlo method. In addition, the heating plan obtained by the calculation method according to the present invention enables a sum of errors from an intended shape to be prematurely reduced by a smaller number of heating wires than a heating plan obtained by a conventional calculation method. Therefore, with the calculation method according to the present invention, a heating plan that reduces error with a smaller amount of heating by including a large deformation can be created. Furthermore, with the calculation method according to the present invention, since Bayesian optimization is adopted, an assessed value distribution can be visualized. In addition, using a neural network that has already been constructed to output a training data group enables a single heating wire to be determined in about two seconds.

By heating (for example, linearly heating) a plate (in particular, a metal plate) based on a heating plan calculated by the calculation method according to the present invention, the plate can be deformed to the intended shape or to a shape that approximates the intended shape. Heating of the plate can be performed by a worker or performed automatically by a machine. The heating may be sequentially performed or concurrently performed in plurality according to the n-number of heating conditions candidates. From the perspective of being able to deform the plate to a shape that more closely approximates the intended shape, heating is preferably performed sequentially. In this manner, bending work and strain relief by heating can be performed with respect to the plate.

A method (deformation method) of heating and deforming a plate according to the heating plan described above can include the steps of: heating a plate using an n-th heating conditions candidate outputted by an n-th (n≥1) attempt and deforming the plate: measuring a three-dimensional shape of the deformed plate; comparing the measured three-dimensional shape of the plate and an n-th shape candidate that is an analysis result of a finite element structural analysis performed in the n-th attempt with each other; and heating a plate based on a result of the comparison so that a three-dimensional shape of the plate approximates the analysis result.

The measurement of the three-dimensional shape of the plate described above can be performed using a three-dimensional measuring instrument. The three-dimensional measuring instrument may be a contact measuring instrument or a contactless measuring instrument of a scanning laser probe type or an optical type. According to the deformation method, the plate can be deformed to a shape that more closely approximates the intended shape.

The heating described above is not particularly limited and can be performed by a heating method using known or conventional heat sources such as gas heating, laser heating, TIG welding, MIG welding, and MAG welding.

An example of a device that automatically performs deformation of a plate based on the heating plan described above includes a device (a plate deformation device) equipped with a program for executing the deformation method described above. Specifically, for example, the plate deformation device can include a heating unit that heats a plate and a control unit that controls the deformation device. The control unit is provided so as to be capable of reading the heating plan described above and provided to control the heating unit so as to heat the plate according to the heating plan. An example of the plate deformation device that automatically performs deformation of a plate by a machine is a self-propelled AI heating robot.

Preferably, the plate deformation device includes: deforming means (deforming means (A)) which heats a plate using an n-th heating conditions candidate outputted by an n-th (n≥1) attempt to deform the plate: measuring means which measures a three-dimensional shape of the deformed plate; comparing means which compares the measured three-dimensional shape of the plate and an n-th shape candidate that is an analysis result of a finite element structural analysis performed in the n-th attempt with each other; and deforming means (deforming means (B)) which heats a plate based on a result of the comparison so that a three-dimensional shape of the plate approximates the analysis result.

When using the plate deformation device, information (dimensions, material, and the like) of a plate that is a processing object, an intended shape, a heating information database (a heat input amount, a heating method, a heating rate, a method of firing, a presence or absence of cooling water, and a plastic strain), and the like are inputted to the plate deformation device. In addition, the plate deformation device may further include one or more of means which generates the heating plan, means which outputs the heating plan and a deformation prediction from the means that generates the heating plan, means which outputs an error between the deformation prediction and the intended shape and which provides a feedback, and means which generates a next heating plan based on the feedback.

### [Recording Medium]

By storing the calculation method according to the present invention in a recording medium, a recording medium storing the calculation method according to the present invention can be obtained. The recording medium is a computer-readable recording medium that stores the program described above.

The recording medium is a recording medium capable of providing a computer with the program described above and causing the computer to execute the program. Examples of the recording medium include a CD-ROM, a flexible disk, a hard disk, a magnetic tape, a magneto optical disk, and a non-volatile memory card.

### [Device]

A device according to the present invention is a device (computer system) including a calculating unit for executing an operation of acquiring a heating plan by the calculation method according to the present invention. For example, the device is constituted of the calculating unit, a display unit, a recording medium, a keyboard, a pointing device, and the like.

The calculating unit is a central processing device that controls the entire computer. The display unit displays various input conditions and analysis results in control executed by the calculating unit. The storage unit is a recording medium that stores analysis results derived by the calculating unit and the like. The keyboard is used by a worker to input the various input conditions or the like. The pointing device is constituted of a mouse, a trackball, or the like.

More specifically, the device includes: a plastic strain estimating module which estimates a plastic strain based on heating conditions inputted by a user; and a heating plan calculating module which calculates a heating plan based on a processing object (a material, a shape, dimensions, and the like of the processing object) inputted by the user, an intended shape, and the plastic strain. A database creating module which creates a heating conditions database by accumulating, in plurality, the plastic strain estimated by the plastic strain estimating module may be included. In this case, the heating plan calculating module calculates a heating plan based on the processing object inputted by the user, the intended shape, and the heating conditions database. Using the heating conditions database enables analysis accuracy and a calculation speed in internal processing to improve.

Examples of the heating conditions include a heat input amount, heating means, a heating rate, a heating shape, a presence or absence of cooling water or an amount of cooling water, and the number of times heating is performed. The heating conditions may otherwise include a propriety of selection of a heating shape other than a straight line or a curved line such as triangular heating, spot heating, or V-shape heating, setting a no-heating region, a propriety of performing press working for imparting a uniform curvature in advance, feedback of shape measurement to selection of the number of heating (five, ten or the like), selection of an optimization algorithm (Monte Carlo, Bayesian optimization, deep reinforcement learning, or the like), setting of an assessment method of a shape (a displacement error of an overall shape, a curvature assessment for each region, a global-local hybrid assessment, or the like), or selection of a termination angle of an abrupt angular variation when searching for a heating wire of a curved line (20 degrees, 45 degrees, or the like). In addition, by calculating the heating plan described above, for example, a heating position, the number of times heating is to be performed, and the like are to be shown in addition to the heating conditions described above.

The respective components, combinations of the components, and the like of the present disclosure described above are merely examples and components can be added, omitted, replaced, and modified as deemed appropriate without departing from the gist of the present disclosure. In addition, the present invention is not limited by the embodiment and is limited solely by the description of the appended claims.

### EXAMPLES

While the present invention will be described below in greater detail based on examples, it is to be understood that the present invention is not solely limited by the following examples.

### First Example (Bending Work: Bowl Shape)

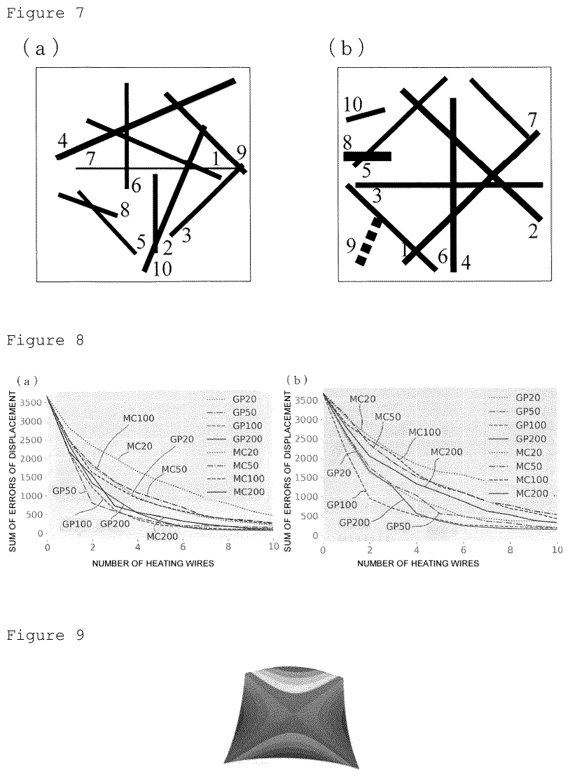

A heating plan with a bowl shape as an intended shape was created according to the flow chart shown in FIG. 1. FIG. 5 shows the intended shape. As an original shape, two types including a 4 mm-thick sheet-like metal plate and an 8 mm-thick sheet-like metal plate (both a 500 mm×500 mm square) were used. As training data to be inputted, six variables including a midpoint of a heating wire, a length of the heating wire, an angle of the heating wire, a heating surface, and a heat input amount were used. A Monte Carlo method and a heating plan according to the flow chart shown in FIG. 1 were compared with each other under conditions of calculating the intended shape described above. FIG. 6 shows a heating plan calculated based on an 8 mm-thick model and FIG. 7 shows a heating plan calculated based on a 4 mm-thick model. In FIG. 6 and FIG. 7, (a) indicates a heating plan obtained by the Monte Carlo method and (b) indicates a heating plan obtained along the flow chart shown in FIG. 1 respectively. Numerals in FIG. 6 and FIG. 7 indicate values of n. Note that in the heating plan obtained in each example, a heating wire on a front surface is depicted by a solid line and a heating wire on a rear surface is depicted by a dotted line.

FIG. 8 is a graph showing a relationship between the number of heating wires and a sum of errors ((a) shows an 8 mm-thick model and (b) shows a 4 mm-thick model). In FIG. 8, MC denotes a heating plan obtained by the Monte Carlo method and GP denotes a heating plan obtained along the flow chart shown in FIG. 1 respectively. Note that in the graph, a numeral described after “GP” or “MC” indicates the number of deformation analyses per one heating wire. As shown in FIG. 8, an error transition of GP enables a sum of errors to be reduced with a smaller number of heating wires as compared to an error transition of MC and a difference between the two was particularly large in the 4 mm-thick model. Since a large deformation due to an out-of-plane deformation caused by a transverse contraction occurs in a thin plate, whether or not such a deformation can be discovered by a search conceivably contributes toward the difference. In addition, as shown in FIG. 7 (b), with the 4 mm-thick model, a large deformation is obtained by applying a large heat input to an end portion of the steel plate to cause the steel plate to contract and by drawing the steel plate in addition to bending.

### Second Example (Bending Work: Saddle Shape)

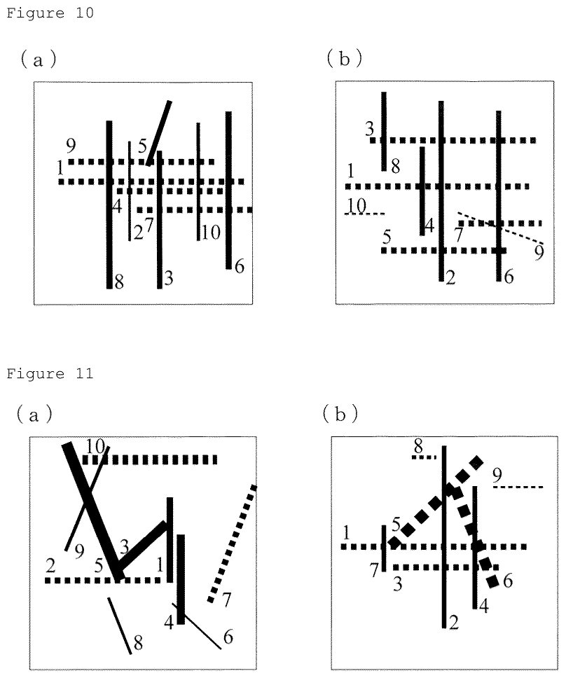

A heating plan was created in a similar manner to the first example with the exception of adopting a saddle shape shown in FIG. 9 as the intended shape. In addition, a Monte Carlo method and a heating plan according to the flow chart shown in FIG. 1 were compared with each other under conditions of calculating the intended shape described above. FIG. 10 shows a heating plan calculated based on an 8 mm-thick model and FIG. 11 shows a heating plan calculated based on a 4 mm-thick model. In FIG. 10 and FIG. 11, (a) indicates a heating plan obtained by the Monte Carlo method and (b) indicates a heating plan obtained along the flow chart shown in FIG. 1 respectively. Numerals in FIG. 10 and FIG. 11 indicate values of n.

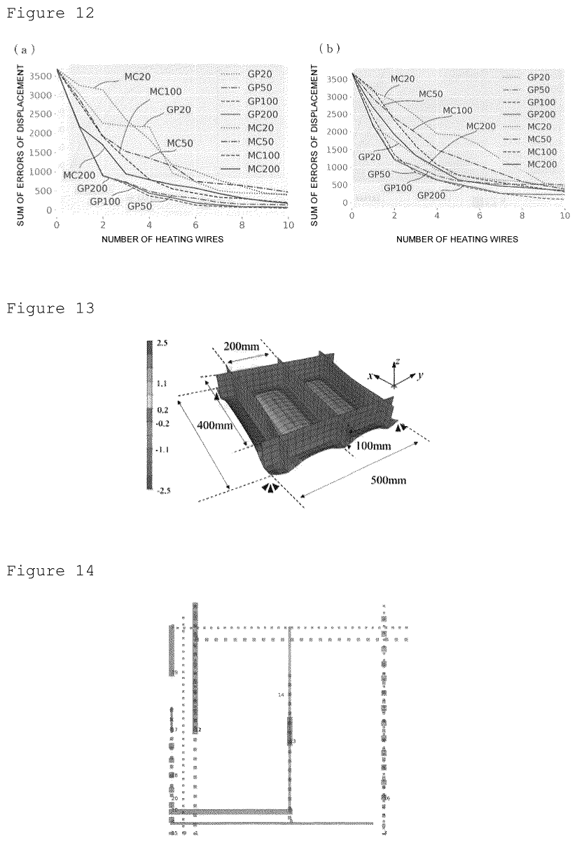

FIG. 12 is a graph showing a relationship between the number of heating wires and a sum of errors ((a) shows an 8 mm-thick model and (b) shows a 4 mm-thick model). In FIG. 12, MC denotes a heating plan obtained by the Monte Carlo method and GP denotes a heating plan obtained along the flow chart shown in FIG. 1 respectively. Note that in the graph, a numeral described after “GP” or “MC” indicates the number of deformation analyses per one heating wire. As shown in FIG. 12, in both the 4 mm-thick model and the 8 mm-thick model, it was confirmed that an error transition of GP enables a sum of errors to be reduced with a smaller number of heating wires as compared to an error transition of MC. In addition, as shown in FIG. 11, in the 4 mm-thick model, an occurrence of drawing by using a heating wire with a large heat input at center was confirmed.

As shown in the first and second examples, it was confirmed that, with the calculation method according to the present invention, a heating plan that reduces error with a smaller number of heating wires by efficiently using a large deformation can be created.

### Third Example (Strain Relief: Stiffening Structure)

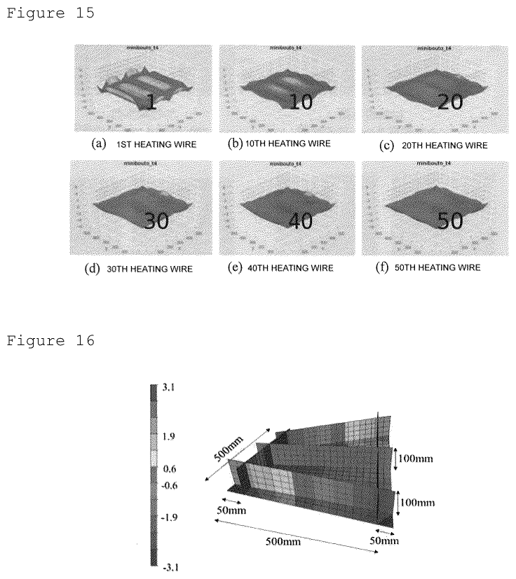

An angular deformation created when fabricating a stiffening structure shown in FIG. 13 by welding was modeled and a heating plan for removing a strain of the model was created according to the flow chart shown in FIG. 1. The obtained heating plan is shown in FIG. 14. With the heating plan, a situation of heating a rear side of rib materials was confirmed. FIG. 15 shows a deformation analysis result when performing heating. FIG. 15 enables how a strain is removed to be confirmed. While it is difficult to remove a strain in two central sections enclosed by rib materials with conventional art, it was confirmed that the strain is removed in a favorable manner with the heating plan obtained by the calculation method according to the present invention.

### Fourth Example (Strain Relief: Torsional Deformation)

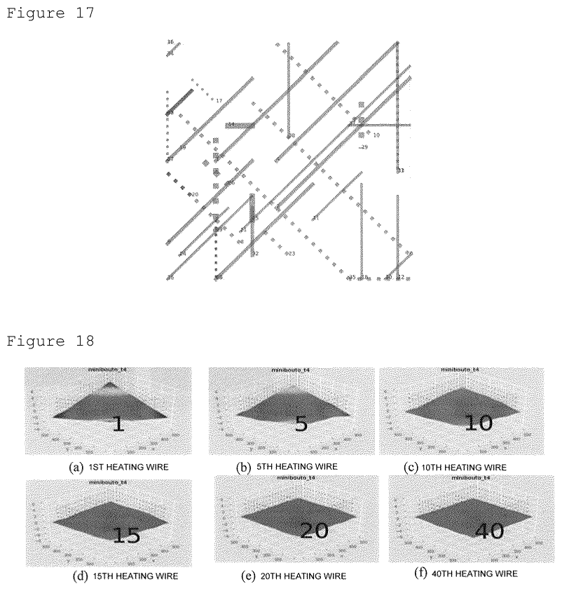

When fabricating a stiffening structure, a torsional deformation may occur depending on welding conditions. A model (FIG. 16) reproducing such a torsional deformation was created and a heating plan for removing a strain of the model was created according to the flow chart shown in FIG. 1. The obtained heating plan is shown in FIG. 17. In the heating plan, it was confirmed that the rear of rib materials was heated with a large heat input in addition to a heating wire that fabricates a twisting form in a lateral plate. FIG. 18 shows a deformation analysis result when performing heating. FIG. 18 enables how a strain is removed to be confirmed. If a strain created by welding a structure can be automatically removed in this manner, such strain removal can be used in the fabrication of various structures.

### Fifth Example (Visualization of Assessment Distribution in Bayesian Optimization: Bowl Shape)

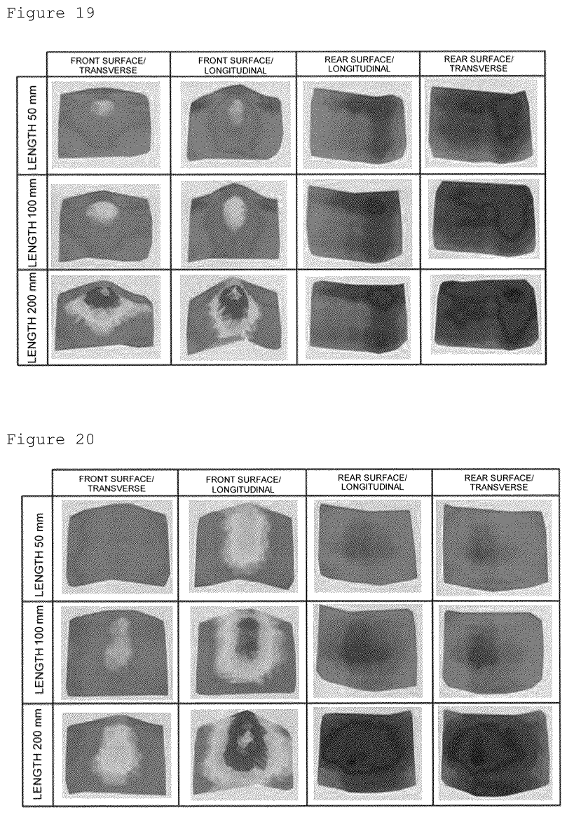

In a Bayesian optimization, in addition to searching for an optimal heating conditions candidate, an assessed value of output can be estimated as a function. In consideration thereof, among the six variables, namely, the midpoint of a heating wire, the length of the heating wire, the angle of the heating wire, the heating surface, and the heat input amount used when fabricating the heating plan in the first example, a visualization with an emphasis on coordinates (x, y) of the midpoint of the heating wire is shown in FIG. 19 (first heating wire) and in FIG. 20 (second heating wire). Each assessment distribution represents assessed values of the midpoint when the length of the heating wire, the heating surface, and a heating angle are fixed. As shown in FIG. 19, an assessment of the visualized view of the length of 200 mm among two left-side columns is high. Therefore, the visualization of the first heating wire reveals that a heating wire with a long heating wire length in a transverse direction on the front surface or a longitudinal direction on the front surface has a high assessed value and, in particular, a midpoint is preferably placed at center of a steel plate. Furthermore, as shown in FIG. 20, an assessment of the visualized view of the length of 200 mm among two left-side columns is high in a similar manner to FIG. 19. Therefore, the visualization of the second heating wire reveals that a heating wire that is orthogonal to the first heating wire is optimal. In this analysis, while heating wires in oblique directions are not executed due to difficulty of understanding in the visualization in FIG. 19, heating wires in oblique directions can be handled in a system using Bayesian optimization.

### Sixth Example (Visualization of Assessment

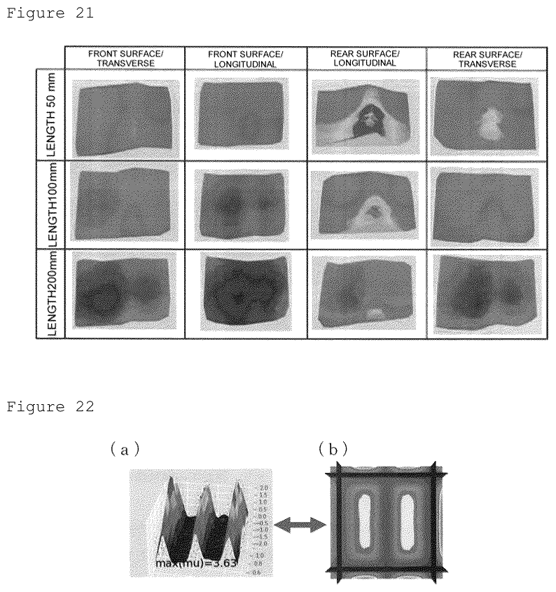

distribution in Bayesian optimization: saddle shape) In a similar manner to the fifth example, among the six variables, namely, the midpoint of a heating wire, the length of the heating wire, the angle of the heating wire, the heating surface, and the heat input amount used when fabricating the heating plan in the second example, a visualization with an emphasis on coordinates (x, y) of the midpoint of the heating wire is shown in FIG. 21 (tenth heating wire). In a similar manner to the case of the bowl shape, it was confirmed that the assessed value y is estimated from the six design variables.

As shown in the fifth and sixth examples described above, it was confirmed that the calculation method according to the present invention enables a complex function shape to be estimated and visualized.

Seventh example (Visualization of assessment distribution in Bayesian optimization: strain relief)

Visualization of heating wires for strain relief in a stiffening structure was performed. In a similar manner to the fifth example, among the six variables, namely, the midpoint of a heating wire, the length of the heating wire, the angle of the heating wire, the heating surface, and the heat input amount used when fabricating the heating plan in the third example, a visualization with an emphasis on coordinates (x, y) of the midpoint of the heating wire was performed. A visualization result with respect to the first heating wire was as shown in FIG. 22. In FIG. 22, (a) shows a distribution of assessed values when performing heating by the first heating wire and (b) shows a deformation after the heating. As shown in FIG. 22, the formation of three peaks can be confirmed. The three peaks represent rear surfaces of rib materials of the stiffening structure and it is clearly visualized that heating conditions in strain relief of a stiffening structure involves heating the rear of the rib materials on a top-priority basis. This is a visualization of the fact that “since optimal solutions of a stiffening structure are subject to strict constraint conditions, the number of optimal solutions is small”.

### Eighth Example (Visualization of Assessment Distribution in Bayesian Optimization: Strain Relief)

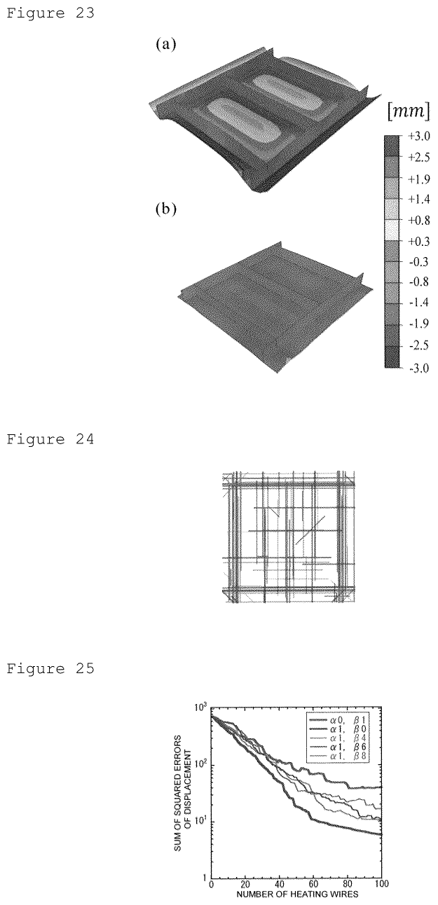

Visualization of heating wires for strain relief in a stiffening structure was performed. In a similar manner to the seventh example, among the six variables, namely, the midpoint of a heating wire, the length of the heating wire, the angle of the heating wire, the heating surface, and the heat input amount used when fabricating the heating plan in the third example, a visualization with an emphasis on coordinates (x, y) of the midpoint of the heating wire was performed. In FIG. 23, (a) shows an analysis model of a stiffening structure used in creating a heating plan and (b) shows a deformation analysis result when performing heating according to the obtained heating plan. FIG. 24 shows the calculated heating plan and FIG. 25 shows an error transition in creation of the heating plan. As shown in FIG. 24, according to the obtained heating plan, a rear side of rib materials is heated and, further, center of a section enclosed by rib materials is heated from a front surface. In addition, as shown in FIG. 23, it is revealed that the heating plan can realize strain relief of a welding deformation from 3 mm to 0.1 mm. In addition, from FIG. 25, it can be confirmed that an error converges in a smaller number of searches in the eighth example to which the present invention has been applied as compared to a conventional Monte Carlo method in which searches are randomly performed in a conventional manner. Reducing the number of searches is important, given that work efficiency is maximized by minimizing the number of searches.

### Ninth Example (Visualization of Assessment Distribution in Bayesian Optimization: Strain Relief)

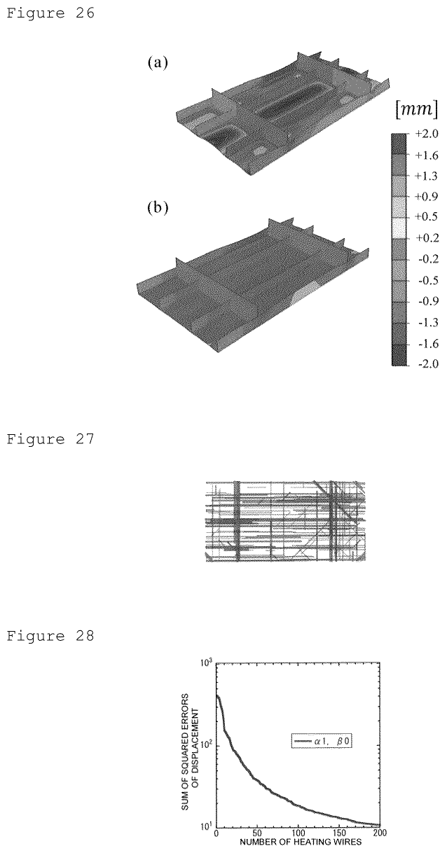

Visualization of heating wires for strain relief in a stiffening structure was performed. In a similar manner to the seventh example, among the six variables, namely, the midpoint of a heating wire, the length of the heating wire, the angle of the heating wire, the heating surface, and the heat input amount used when fabricating the heating plan in the third example, a visualization with an emphasis on coordinates (x, y) of the midpoint of the heating wire was performed. In FIG. 26, (a) shows an analysis model of a stiffening structure used in creating a heating plan and (b) shows a deformation analysis result when performing heating according to the obtained heating plan. FIG. 27 shows the calculated heating plan and FIG. 28 shows an error transition in creation of the heating plan. As shown in FIG. 27, according to the obtained heating plan, a rear side of rib materials is heated and, further, center of a section enclosed by rib materials is heated from a front surface in a similar manner to the eighth example. In addition, as shown in FIG. 26, it is revealed that the heating plan can realize strain relief of a welding deformation from 2 mm to 0.3 mm. Furthermore, from FIG. 28, it can be confirmed that an error converges in a smaller number of searches in the ninth example to which the present invention has been applied as compared to a conventional Monte Carlo method in which searches are randomly performed in a conventional manner. Reducing the number of searches is important, given that work efficiency is maximized by minimizing the number of searches.

### REFERENCE SIGNS LIST

31 training data group output step
S2 Bayesian optimization step
S3 finite element analysis step
1 analysis model
2 plate
3 element
3a element in first shape candidate
3b element in intended shape
4 node
4a node in first shape candidate
4b node in intended shape
5a first heating conditions candidate
5b second heating conditions candidate
D out-of-plane direction displacement amount of node

1. A calculation method of a heating plan for deforming a plate by heating, the calculation method comprising:
a Bayesian optimization step of performing a Bayesian optimization by inputting a training data group including a plurality of combinations of heating conditions that include a heating shape having been set at an arbitrary location of an analysis model for an original shape being a shape of the plate and an assessed value of a deformed shape that has been calculated based on the heating conditions and determining a heating conditions candidate; and
a finite element analysis step of converting the heating conditions candidate into strain data and performing a structural analysis based on a finite element method by inputting the strain data to output a shape candidate.

2. The calculation method according to claim 1, comprising a training data group output step of outputting the heating conditions and the deformed shape by deformation prediction using a neural network.

3. The calculation method according to claim 1, comprising:
a Bayesian optimization step of performing the Bayesian optimization with the shape candidate obtained in the finite element analysis step as the original shape and determining a next heating conditions candidate; and
a finite element analysis step of converting the next heating conditions candidate into strain data and performing a structural analysis based on a finite element method by inputting the strain data to output a next shape candidate.

4. The calculation method according to claim 3, wherein the Bayesian optimization and the subsequent finite element analysis step are repetitively performed with the next shape candidate as the original shape to acquire an intended shape and a plurality of heating conditions candidates for obtaining the intended shape.

5. The calculation method according to claim 1, wherein the heating shape includes a heating wire and the heating conditions include a midpoint of the heating wire, a length of the heating wire, an angle of the heating wire, a heating surface, and a heat input amount.

6. The calculation method according to claim 1, being a calculation method of a heating plan for performing bending work of a plate or strain relief of a plate by heating.

7. A program for executing the calculation method according to claim 1.

8. A computer-readable recording medium that stores the program according to claim 7.

9. A device comprising a calculating unit that executes acquisition of a heating plan according to the calculation method according to claim 1.

10. The device according to claim 9, the device is for calculating a heating plan for deforming a plate by heating, the device comprising:
a plastic strain estimating module which estimates a plastic strain based on heating conditions inputted by a user; and a heating plan calculating module which calculates a heating plan based on a processing object inputted by the user, an intended shape, and the plastic strain.

11. The device according to claim 10, comprising a database creating module which creates a heating conditions database by accumulating, in plurality, the plastic strain estimated by the plastic strain estimating module, wherein in the heating plan calculating module, a heating plan is calculated based on a processing object inputted by the user, an intended shape, and the heating conditions database.

12. A deformation method of heating and deforming a plate based on a heating plan calculated by the calculation method according to claim 1.

13. A plate deformation device equipped with a program for executing the deformation method according to claim 12.

14. A plate deformation device comprising a heating unit that heats a plate and a control unit that controls a deformation device, wherein the control unit is provided so as to be capable of reading the heating plan according to claim 1.

15. The plate deformation device according to claim 14, comprising: deforming means (A) which heats a plate using an n-th heating conditions candidate outputted by an n-th (n≥1) attempt to deform the plate: measuring means which measures a three-dimensional shape of the deformed plate; comparing means which compares the measured three-dimensional shape of the plate and an n-th shape candidate that is an analysis result of a finite element structural analysis performed in the n-th attempt with each other; and deforming means (B) which heats the plate based on a result of the comparison so that a three-dimensional shape of the plate approximates the analysis result.

16. A production method for a deformed plate comprising a step of heating and deforming a plate based on a heating plan calculated by the calculation method according to claim 1.

17. The calculation method according to claim 1, comprising entering an intended shape of the plate that is a processing object when using the calculation method of the heating plan.

18. The calculation method according to claim 1, the training data group comprises an analysis model of an intended shape of the plate that is a processing object.
